(19) United States
(12) Patent Application Publication
(10) Pub. No.: US 2015/0339327 A1
(43) Pub. Date: Nov. 26, 2015

(54) CONVERSATION ANALYTICS

(71) Applicant: NewVoiceMedia, Ltd., Basingstoke (GB)

(72) Inventors: Ashley Unitt, Basingstoke (GB); Alan McCord, Frisco, TX (US)

(21) Appl. No.: 14/555,912

(22) Filed: Nov. 28, 2014

Related U.S. Application Data
(63) Continuation of application No. 14/286,358, filed on May 23, 2014, now abandoned.

(51) Int. Cl. G06F 17/30; G10L 25/48

(52) U.S. Cl. CPC G06F 17/30289; G06F 17/3028; G10L 25/48

(57) ABSTRACT

A system for conversation analytics comprising an analytics server stored and operating on a network-connected device that receives and processes conversations from various sources over a communications network, a plurality of communication bridges that may connect to and receive communication data from various communication endpoints, a media server that receives communication data from the bridges and provides this data to the analytics server for analysis, and a database that may store data from various elements of the system and provide them as needed for future reference.

### CROSS-REFERENCE TO RELATED APPLICATIONS

This application is a continuation of U.S. patent application Ser. No. 14/286,358 entitled “CONVERSATION ANALYTICS” filed on May 23, 2014, the entire specification of which is incorporated herein by reference.

### BACKGROUND OF THE INVENTION

1. Field of the Art

The disclosure relates to the field of communications tracking, and more particularly to the field of recording and analyzing conversations across varied communications media.

2. Discussion of the State of the Art

In the field of communications monitoring, there is frequently a need to record and analyze communications for various purposes, such as to identify customer needs (for example, whether they might be a likely purchaser of a new product or service), to identify customer service performance (for example, to grade customer service agent performance or identify if training is needed), or to identify participants in a call such as for law enforcement use.

Current approaches generally rely on simple metrics-based analytics, such as the use of counters and percentages to identify specific qualities of a call or other conversation. For example, in the customer service industry it is a common practice to record customer calls and verify whether a customer service agent spoke specific phrases that are required as a part of a call handling script (such as asking for a customer's name and phone number, or asking whether they are satisfied with the resolution provided at the end of a call). This provides a simple yes/no metric that can be used to score these calls, but provides an inadequate level of granularity regarding the customer's actual needs or activities. For example, they may simply state that they are satisfied with the call out of frustration, so that they may hang up and do something else, or they may have called about a small issue that relates to a larger concern that is not immediately apparent based on the limited monitoring taking place. Additionally, it does not take into account any customer activities outside of that specific call, such as online activity (perhaps browsing for technical support via a company website), or additional calls to a contact center.

What is needed, is a means to analyze various attributes of conversations across different media to capture a conversation in its entirety, as well as to analyze various attributes of the captured conversation media to identify patterns or trends on a larger scale as well as to produce useful metadata on a level not possible with current approaches.

### SUMMARY OF THE INVENTION

Accordingly, the inventor has conceived and reduced to practice, in a preferred embodiment of the invention, a system for conversation analytics and various methods for conversation analytics utilizing the system of the invention.

According to a preferred embodiment of the invention, a system for conversation analytics comprising an analytics server stored and operating on a network-connected device that receives and processes conversations from various sources over a communications network (such as a public switched telephone network (PSTN), Internet, GSM or other cellular communication networks, or any other appropriate network for electronic communications), a plurality of communication bridges that may connect to and receive communication data from various communication endpoints (such as a cellular bridge to receive data from cellular phones or other devices communicating via a cellular network), a media server that receives communication data from the bridges and provides this data to the analytics server for analysis, and a database that may store data from various elements of the system and provide them as needed for future reference, is disclosed.

According to the embodiment, users may communicate via any communication network as usual (such as talking on a mobile phone to communicate via a cellular network, or browsing the Internet on a personal computing device). This communication may be received or requested by a communications bridge, which may then provide the communication data to a media server. In this manner, multiple communications bridges may provide data to a single media server, effectively unifying various communications means into a single electronic data stream that may then be provided by the media server to an analysis server for processing. According to the embodiment, this communications data may also be stored in a database for future reference, such as to retrieve historical data and perform further analysis on it, or to merge historical data with newly-received data as needed (as is described below, referring to FIG. 7, a process for merging new data with stored data to add new content to a conversation). According to the embodiment, data may be provided to an analysis server that then processes the communications according to stored (optionally configurable) parameters, and identifies features and events as well as producing metadata that may be stored for future reference, such as to sort, categorize, graph, or otherwise process communications data for review, presentation, or manual analysis by a human analyst.

According to the embodiment, an analysis server may process communication data and such analysis may result in the identification of various features or events, such as “communications events” that may be any general communication-based technical event (for example, the beginning and ending of a telephone call, or web interaction such as search queries submitted or web pages requested), or “semantic events”, that may be any content-based event of a communication and may be further classified as “data events” such as the point at which metadata was associated with a communication, indicating the exact position in the conversation at which the metadata was identified and “tagged” or otherwise associated with the conversation, “business events” such as purchases, returns, loan applications, insurance claims, cell phone activations, or any other such business-relevant event or transaction according to the nature of the business being conducted in a conversation, or “linguistic events” that may be any language-specific event such as particular words, phrases, or phonemes spoken (or typed, etc. according to the nature of the communication medium), or groups or patterns thereof (such as, for example, a customer saying “unhappy” followed closely by “new phone”, or repeatedly referring to a competitor by name in casual conversation, as might indicate that they are considering a competitor's product or service offerings).

Further according to the embodiment, an analysis server may associate metadata with communication data, such as explicitly declaring specific events or features (such as described above) and noting their position within a conversation, and such metadata may be associated with a conversation in a variety of ways such as by “tagging” or associating metadata elements with specific points in a communication (as is a common practice in metadata association in the art, such as with audio files that may be “tagged” with metadata at specific points during playback), or by associating metadata with a specific communication such as to indicate properties particular to that communication data (such as identifying a customer's mobile phone device information and associating this information with a call they placed from that device or identifying a customer's web browser from a tracking cookie), or association with a conversation in general such as to indicate features that are common to all communications that take place within that conversation (such as to identify an overall theme of the conversation, or to identify conversation participants, or any other such global metadata that may relate to all conversation contents or elements). In this manner, metadata may be used with varying levels of granularity and abstraction to identify features as appropriate, and in so doing the association of the metadata itself may be seen as intrinsically indicative of certain information, further enhancing analysis operations and any information obtained as a result.

It should be appreciated that, according to the embodiment, an analysis server may be connected to or integrated with various public or private external or third-party products or services (such as public social networking services, or private customer databases, for example) for such purposes as data gathering, for example via a software application programming interface (API) or other integration means. For example, an analysis server may be connected to a social media network for such purposes as collecting publicly available information on a customer, for example to determine potential conversation topics for identification during analysis operations.

According to another preferred embodiment of the invention, a method for conversation analytics comprising the steps of receiving communication data from sources, providing communication data to an analysis server, analyzing the communications data, and storing the results of analysis, is disclosed. According to the embodiment, the method described is an overview of general operation of a system for conversation analytics as described by the invention, and more specific functions are described below.

In a further embodiment of the invention, a method for identifying conversation elements across various communications media comprising the steps of receiving communications data from multiple different sources (such as both Internet-based and telephone communications), analyzing the communications data, reviewing the results of the analysis for similarities (such as identifying shared features between the different communications data, or between current data and previously-stored data), creating an association between the communications data based on identified similarities, and storing the data according to the association, is disclosed. In this manner, new communication data may be associated with a previously-analyzed or otherwise known conversation, enabling the expansion of conversation as appropriate by incorporating new data. Additionally, in an optional end step a conversation may be re-analyzed in whole or in part, now that new data has been incorporated. It may be appreciated that this functionality may enable the identification of new features or details in a conversation, due to the incorporation of new data. It should be appreciated that this re-analysis step may be repeated multiple times as new features and details are identified, depending upon a threshold set on the significance of newly identified features, thereby effecting a continuous looping operation that may improve over time through the incorporation of new data and the repeated execution of processing tasks as described above.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram of an exemplary system architecture for conversation analytics, according to a preferred embodiment of the invention.

FIG. 6 is a method flow diagram of an exemplary method for conversation analytics, illustrating an overview of system function according to a preferred embodiment of the invention.

FIG. 7 is a method flow diagram of an exemplary method for conversation analytics, illustrating a method for forming conversations.

### DETAILED DESCRIPTION

The inventor has conceived, and reduced to practice, a system for conversation analytics and various methods for conversation analytics utilizing the system of the invention.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be noted that particular embodiments include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### DEFINITIONS

A “communication”, as used herein, refers to any particular interaction between a plurality of individuals, utilizing any appropriate communications devices, media, or networks, such as a particular phone call, internet browsing session, a single email, web chat, video or audio media stream, social media posting, or other such specific communication instances.

A “conversation”, as used herein, refers to a grouping of multiple communications that may share a common theme or topic, such as multiple emails sent back and forth between two individuals to discuss an issue, or a telephone call and a follow-up telephone call regarding the same topic, or any other such instances of multiple individual communications that may be associated in such a way.

“Metadata”, as used herein, refers to discrete portions of meaningful information that may be produced or extracted from media information such as communications and that may be used for such purposes as enhancing the content of the media with which they are associated, such as (for example) metadata identifying a speaker's name in a conversation, such that listeners unfamiliar with the voice may know to whom it belongs. It should also be noted that metadata may also be inferred or extracted from hardware information, such as (for example) identifying hardware sensor readings on a user's mobile device, or identifying the capabilities of a user's personal computer they are using to browse a webpage or application.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

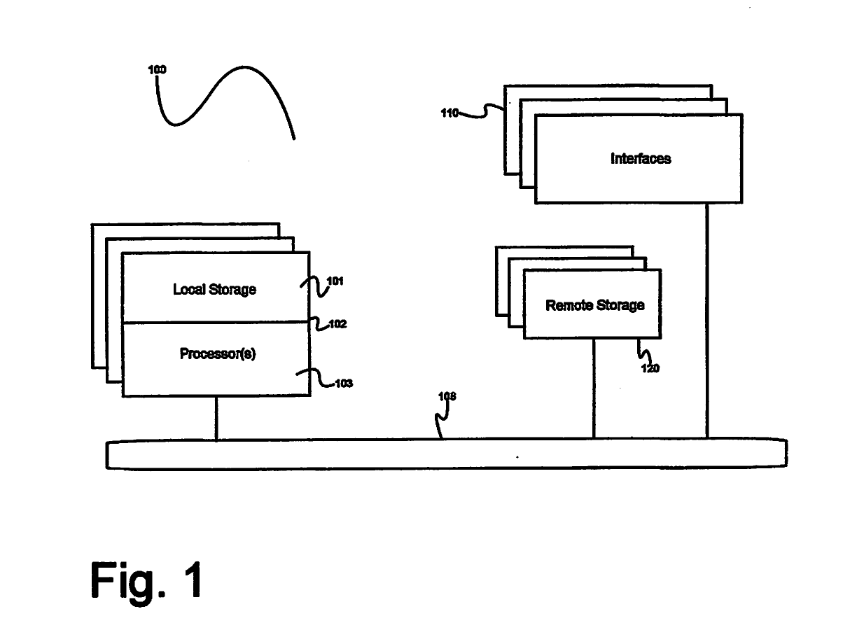

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, Firewire™, PCI, parallel, radio frequency (RF), Bluetooth™ near-field communications (e.g., using near-field magnetics), 802.11 (WiFi), frame relay, TCP/IP, ISDN, fast Ethernet interfaces, Gigabit Ethernet interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include ports appropriate for communication with appropriate media. In some cases, they may also include an independent processor and, in some in stances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory, solid state drives, memristor memory, random access memory (RAM), and the like. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

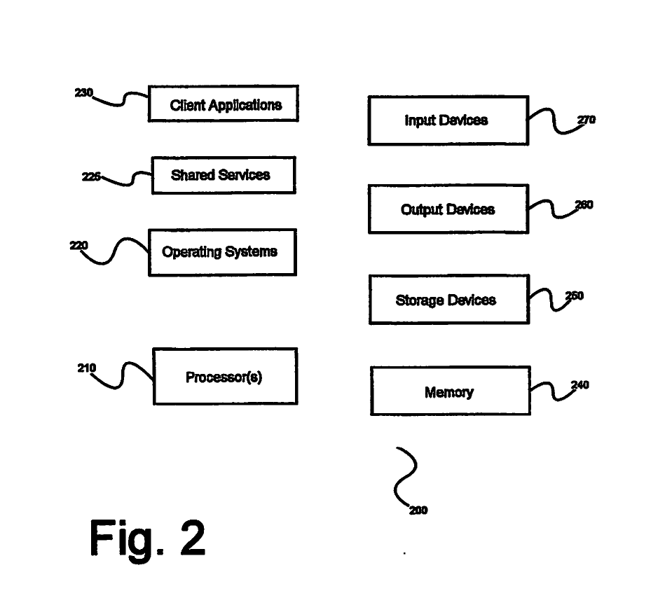

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's Windows™ operating system, Apple's Mac OS/X or iOS operating systems, some variety of the Linux operating system, Google's Android™ operating system, or the like. In many cases, one or more shared services 225 may be operable in system 200, and may be useful for providing common services to client applications 230. Services 225 may for example be Windows™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form. Examples of storage devices 250 include flash memory, magnetic hard drive, CD-ROM, and/or the like.

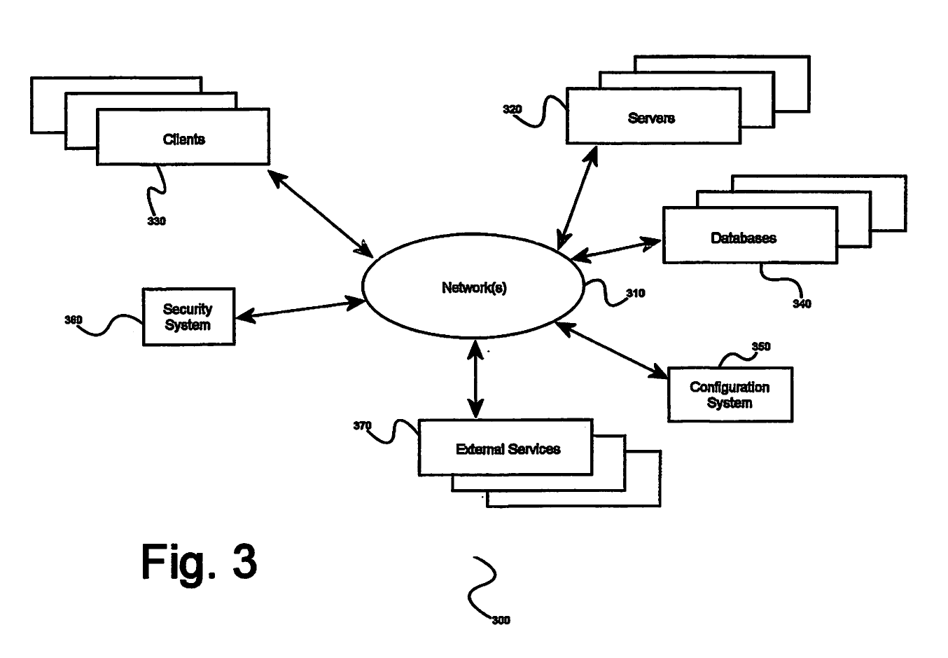

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network, a wireless network (such as WiFi, Wimax, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

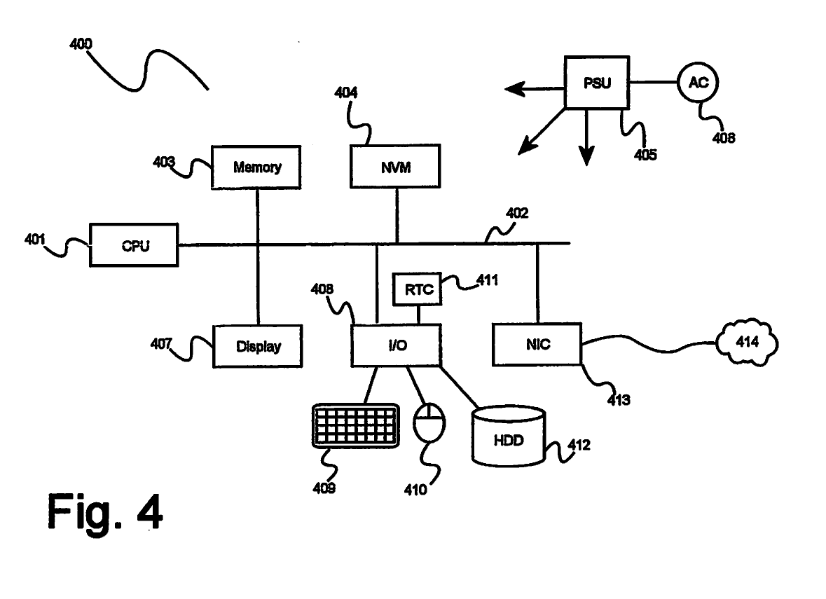

FIG. 4 shows an exemplary overview of a computer system 400 as may be used in any of the various locations throughout the system. It is exemplary of any computer that may execute code to process data. Various modifications and changes may be made to computer system 400 without departing from the broader spirit and scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein.

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

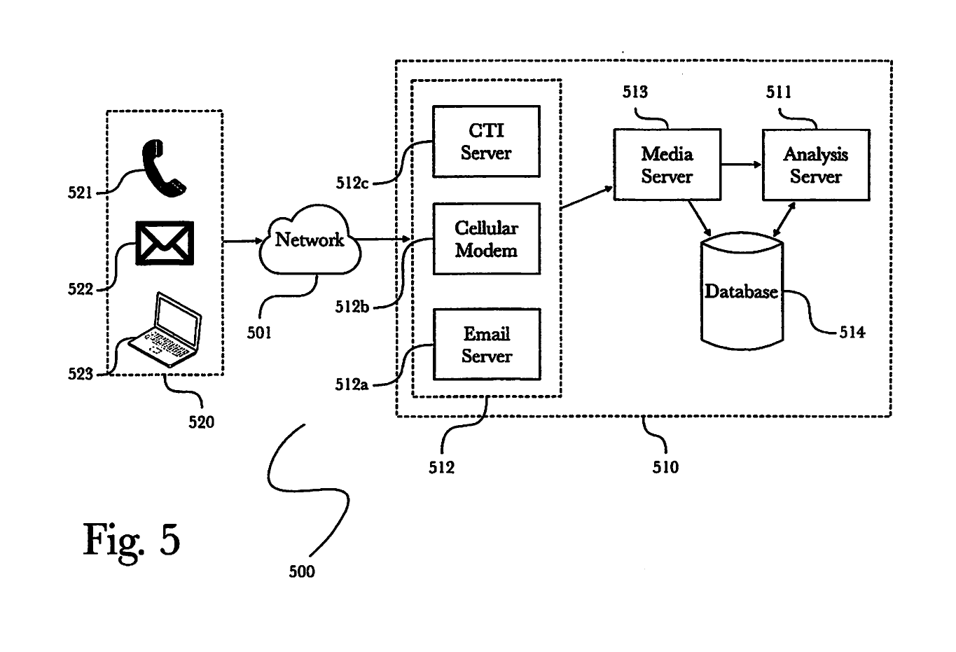

FIG. 5 is a block diagram of an exemplary system architecture 500 for conversation analytics. As illustrated, a conversation analytics system 510 may comprise an analytics server 511 stored and operating on a network-connected device that may receive and process conversations from various sources over a communications network 501 (such as the Internet, GSM or other cellular communication networks, or any other appropriate network for electronic communications), a plurality of communication bridges 512 that may receive communication data from various communication endpoints 520 such as, for example, a telephone 521 communicating via a public switched telephone network (PSTN), an email software application communicating via the Internet or other appropriate data network, or a personal computing device 523 operating a web browser or other software that may be communicating via the Internet, a media server 513 that receives communication data from the bridges 512 and provides this data to the analytics server 511 for analysis, and a database 514 that may store data from various elements of the system and provide them as needed for future reference. It should be appreciated that while a single communications network 501 is shown, this is for illustrative clarity and multiple networks of varying implementation and nature may be utilized according to the invention, and it should be further appreciated that any particular network may accommodate communication utilizing more than one specific protocol or means, such as a cellular network comprising multiple radio frequencies.

According to the embodiment, communication bridges 512 may be any appropriate software or hardware device or means to send and receive communication data, and may vary according to the specific nature of the data or network being interacted with. For example, an email server 512a may be utilized to receive email-based communications over the Internet, or a cellular modem 512b may be utilized to receive communications over a cellular data network, or a CTI server 512c that may receive communication data from telephony-based sources and turn it into useful electronic data to be provided to a media server 513. In this manner, it may be appreciated that such devices or means may server to bridge data from one communication medium (such as a telephone network) to another (such as an internal, IP-based network used to communicate between components of a system 510 for conversation analytics). It should be further appreciated that such devices or means may also be utilized as a media server 513, for example an email server that may receive and process email communications, and it should be noted that the use of any particular device or means as either a bridge or media server may be determined by the functions being performed, rather than the form or function of the device itself. It should be further appreciated that a single device or means (for example, an email server) may function as both a communications bridge 512 and a media server 513, either simultaneously or interchangeably within a single arrangement of a system 510, according to the invention.

According to the embodiment, an analysis server 511 may process communication data and such analysis may result in the identification of various features or events, such as “communications events” that may be any general communication-based technical event (for example, the beginning and ending of a telephone call, or web interaction such as search queries submitted or web pages requested), or “semantic events”, that may be any content-based event of a communication and may be further classified as “data events” such as the point at which metadata was associated with a communication, indicating the exact position in the conversation at which the metadata was identified and “tagged” or otherwise associated with the conversation, “business events” such as purchases, returns, loan applications, insurance claims, cell phone activations, or any other such business-relevant event or transaction according to the nature of the business being conducted in a conversation, or “linguistic events” that may be any language-specific event such as particular words, phrases, or phonemes spoken (or typed, etc. according to the nature of the communication medium), or groups or patterns thereof (such as, for example, a customer saying “unhappy” followed closely by “new phone”, or repeatedly referring to a competitor by name in casual conversation, as might indicate that they are considering a competitor's product or service offerings).

Further according to the embodiment, an analysis server 511 may associate metadata with communication data, such as explicitly declaring specific events or features (such as described above) and noting their position within a conversation, and such metadata may be associated with a conversation in a variety of ways such as by “tagging” or associating metadata elements with specific points in a communication (as is a common practice in metadata association in the art, such as with audio files that may be “tagged” with metadata at specific points during playback), or by associating metadata with a specific communication such as to indicate properties particular to that communication data (such as identifying a customer's mobile phone device information and associating this information with a call they placed from that device), or association with a conversation in general such as to indicate features that are common to all communications that take place within that conversation (such as to identify an overall theme of the conversation, or to identify conversation participants, or any other such global metadata that may relate to all conversation contents or elements). In this manner, metadata may be used with varying levels of granularity and abstraction to identify features as appropriate, and in so doing the association of the metadata itself may be seen as intrinsically indicative of certain information, further enhancing analysis operations and any information obtained as a result.

It should be appreciated that through integration or connection with external resources (such as public social media networking services, or private customer information databases) additional information may be available to an analysis sever 511 for use in operation, for example to determine possible metadata or to further enhance existing information through the inclusion of additional context or details. In this manner the operation of an analysis server 511 may be customized to an extent through configuration of data sources, enabling a tailored approach that may be used to focus on specific types or sources of information, or expanded through the inclusion of additional data sources to make more information available for use in operation, thereby increasing the scope and usefulness of results.

It should be further appreciated that in addition to specific metadata-related information such as communication events or linguistic events, it may be possible to identify contextual information related to a communication or a conversation as a whole, such as through the analysis of communication devices, media types, networks, or external resources associated with the communication or conversation. For example, it may be inferred that two parties are discussing software applications (or more particularly, a specific application depending on analysis results) if they are simultaneously viewing or operating software programs during a conversation. Another, more specific example may be the identification that a person posting to a social network is speaking specifically about a particular product from a particular vendor, based on recent purchase activity associated with a customer account operated by the poster, combined with the content of their posting (such as keywords related to the product). In this manner, not only may metadata be used to identify communication events and features, but the general nature, intent, or other contextual information may also be identified.

Further according to the embodiment, an analysis server 511 may utilize machine learning to improve operation over time, and behavior may be further altered by configuration or calibration by a human user, for example to provide guidelines on desired operation for a particular use case (for example, a bank may want to focus analysis on banking operations such as loan applications or credit reviews). In this manner, it may be appreciated that system behavior may improve over time and operation may continue with or without human interaction as appropriate.

### DETAILED DESCRIPTION OF EXEMPLARY EMBODIMENTS

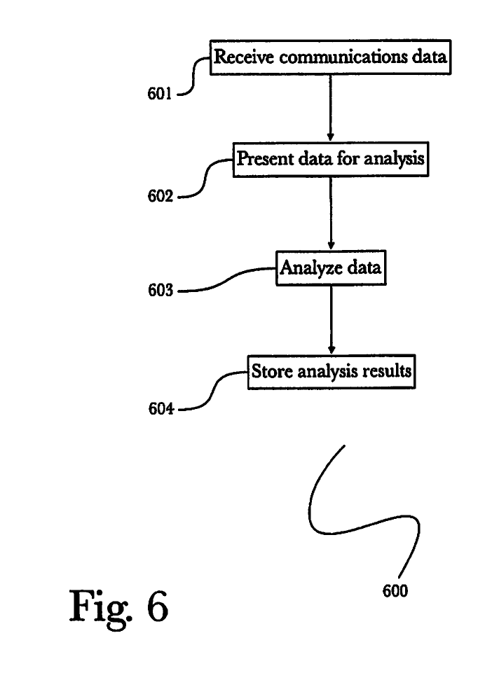

FIG. 6 is a method flow diagram illustrating an exemplary method 600 for conversation analytics, according to a preferred embodiment of the invention. In an initial step 601, communication data may be received such as from various communication bridges (as described previously). This data may vary in nature, such as text-based data (for example, an email message received by an email server), voice data (such as a phone call received by a cellular modem or a CTI server), or other electronic data of any sort that may be received and may be relevant to a conversation (for example, an email server may receive an email attachment, that could be any sort of electronic data such as an image, document, program data, etc.). In a next step 602, communication data may be presented for analysis, such as by an analytics server (as described previously) or by a human analyst. For example, it may be desirable to have a human analyst review communication data to perform manual analysis, such as to calibrate or “train” an automated machine learning algorithm or similar software module stored and operated on an analysis server and improve future operations. In a next step 603, analysis may be performed, such as by an analysis server performing automated analysis of received data (as described above), or by a human user manually reviewing the data presented. In a final step 604, analysis results (and optionally any new learning such as from the results of machine learning behavior or manual input from a human user as described above) may be stored for future reference, such as for future review by a human user to review automated operation, for review by an analysis server for use in machine learning behavior (such as reviewing historical analysis results and re-performing analysis of the communication data utilizing new rules or techniques, and then comparing the two sets of analysis result data), or for inclusion in future operation or learning behaviors.

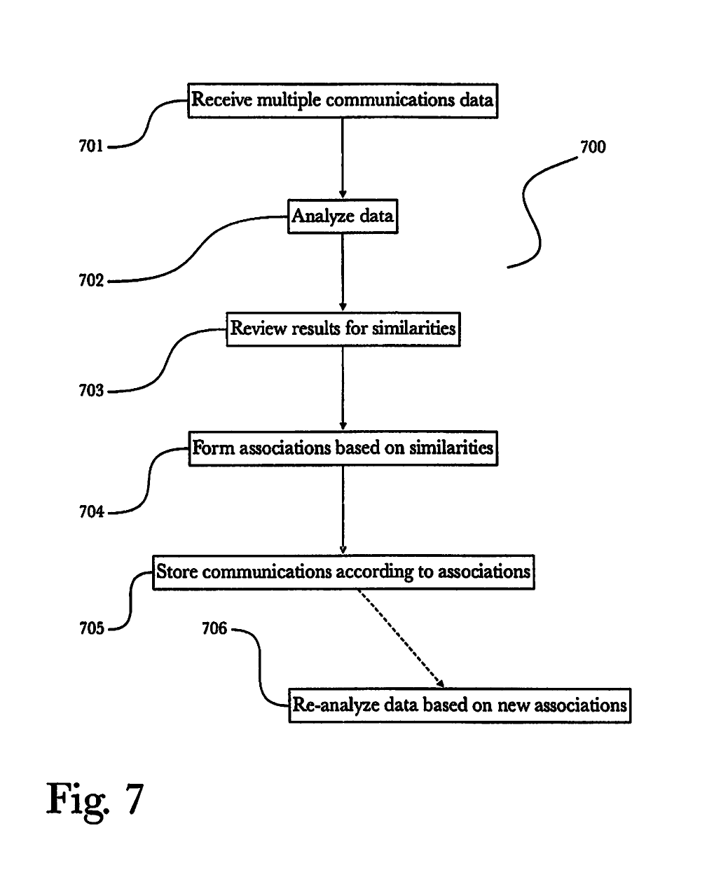

FIG. 7 is a method flow diagram illustrating an exemplary method 700 for conversation analytics, showing a process for forming conversations. In an initial step 701 communications data may be received from multiple different sources, such as (for example) both Internet-based and telephone communications. In a next step 702 the communications data may be analyzed, such as to identify features or events as described previously. Such analysis may vary in scope and detail, such as (for example) analyzing portions of communication, analyzing software or hardware details such as networks or devices utilized, incorporating or analyzing information from external sources such as social media networks, utilizing social graphs to aid in forming associative links, or any other such behavior or operation that may be useful in identifying details or contextual information related to a communication. In a next step 703 the results of the analysis may be reviewed for similarities between the different data sources (such as identifying shared features between the different communications data, or between current data and previously-stored data). In a next step 704 an association between the communications data may be formed based at least in part on identified similarities, for example if two separate communications are identified as having the same participants and a similar theme or topic, they may be associated into a conversation (such as a customer pursuing technical support both online and by calling a contact center). Conversely, an association may instead not be formed if it is determined that two communications are not part of the same conversation, and instead each may be considered a separate conversation (or a part thereof). In a final step 705 the data may be stored according to associations formed in a previous step, thereby unifying various data into a single conversation based on analysis. It may be appreciated that in this manner, new communication data may be associated with a previously-analyzed or otherwise known conversation, enabling the expansion of conversations as appropriate by incorporating new data. Additionally, in an optional end step 706 a conversation may be re-analyzed in whole or in part, now that new data has been incorporated, such as to utilize metadata or other analysis information on the newly-added data to review the conversation as a whole and potentially improve analysis results. It may be appreciated that this functionality may enable the identification of new features or details in a conversation due to the incorporation of new data, and may therefore also be utilized in machine learning behavior to enhance future analysis operations.

The skilled person will be aware of a range of possible modifications of the various embodiments described above. Accordingly, the present invention is defined by the claims and their equivalents.

What is claimed is:

1. A system for conversation analytics, comprising:
an analysis server stored and operating on a network-connected computing device;
a media server stored and operating on a network-connected computing device;
a plurality of communication bridges stored and operating on network-connected computing devices; and
a database stored and operating on a network-connected computing device.
wherein the communication bridges receive a plurality of communication data via a communication network and provide the data to the media server;
wherein the media server receives the plurality of communication data from the communication bridges and provides the data to the analysis server;
wherein the analysis server receives and analyzes the communication data and stores the analysis results in the database; and
wherein the analysis server forms associations based on similarities in the plurality of communication data.

2. The system of claim 1, further wherein the media server stores the communication data and associations in the database.

3. The system of claim 2, further wherein the analysis server performs analysis on stored communication data.

4. The system of claim 1, wherein the media server is also a communication bridge.

5. A method for conversation analytics, comprising the steps:
receiving a plurality of communication data;
presenting the communication data for analysis;
analyzing the communication data;
forming associations based on similarities in the plurality of communication data; and
presenting the results of analysis.

6. The method of claim 5, wherein the analysis is performed by a human user.

7. The method of claim 5, wherein the analysis is performed by an analysis server.

8. The method of claim 5, wherein the results of analysis are presented to a database for storage.

9. The method of claim 5, wherein the multiple communication data are from different communication networks.

10. The method of claim 5, wherein the multiple communication data are from different time periods.

11. The method of claim 10, wherein at least a portion of the communication data was previously stored.

12. The method of claim 11, wherein at least a portion of the stored communication data was previously analyzed.

13. The method of claim 12, wherein at least a portion of the previously analyzed stored communication data is analyzed again after forming associations.
